(19) United States
(12) Patent Application Publication
(10) Pub. No.: US 2009/0273439 A1
(43) Pub. Date: Nov. 5, 2009

(54) Micro-chip ID

(76) Inventor: Richard Selsor, Broken Arrow, OK (US)

Correspondence Address: JAMES RICHARDS, 58 BONING RD, FAYETTEVILLE, TN, 37334, US

(21) Appl. No.: 12/151,143

(22) Filed: May 1, 2008

(51) Int. Cl. H04B 1/38

(52) U.S. Cl. 340/5.61

(57) ABSTRACT

An electronic device worn by a person; in a exemplary embodiment comprising a radio-frequency receiver-transmitter, a CODEC, and a processing element having storage. The device is configured to operate within a location or venue, and if outside the location or venue, to transition to “sleep mode.” The device communicates and interacts with other external systems. Optionally a CODEC, which enables secure communications, encodes and decodes messages and data exchanged with external systems. The CODEC may receive data or codes from the processing element and may send decoded data and or messages to the processing element for storage. The processing element may receive and remit personal data related to the person, including records of personal data and information, events and times, financial or monetary data, important dates and times with reminders, security information including cryptographic keys and encodings.

### RELATED APPLICATIONS

This application is related to and derives priority from U.S. patent application Ser. No. 11/901,872, entitled MICRO-CHIP ID, which is incorporated herein by reference.

### FIELD

The present invention relates to personal identification devices; more specifically the present invention comprises an electronics appliance that is worn by a person, wherein the appliance identifies the person and is utilized to permit the person access to events, services and so forth.

### BACKGROUND

In today's electronic world, the requirement for security is ubiquitous. This translates into control of access to or use of objects, venues, and systems of electronic devices.

What is needed is a compact, reliable and unobtrusive means for controlling access and use.

### OBJECTS

Therefore according to the need for more secure access to objects, locations, venues events, mechanisms and systems, a first object of the invention is an identifying device that identifies the person granted access or permissions, wherein the device is worn or secreted on the person, or on objects carried by the person.

A second object is a very small or compact identifying device that is unobtrusive.

A third object is an identifying device, parts of which may be embedded partially or wholly within the person, and which may communicate with another device such as a computer mouse.

A fourth object is an identifying device that may operate under external power provided to the device, so that no included power sources are needed or required.

A fifth object is an identifying device that operates within the confines or a location or venue and ceases to operate outside a desired area.

A sixth object is an identifying device that receives it power from a specific locale.

And a seventh object is an identifying device that may, as an option, be configured so that it operates in conjunction with a marking or symbol imprinted or made on the person.

The benefits and advantages of the invention will appear from the disclosure to follow. In the disclosure reference is made to the accompanying drawing, which forms a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

In the accompanying drawings and description, a radio frequency identification chip (RFID) is placed inside a ring, wallet, a wrist watch, arm bracelet, in an article of clothing such as a shirt, blouse, or a hat. Or the RFID could be in a cell-phone, laptop computer, eyeglasses or briefcase or container carried by a person. Or the RFID may actually be embedded within the person's body or in the person's clothing. The RFID communicates with an RFID reader under control of a computer. The reader may be embedded, for example, within a computer peripheral device, such as a computer mouse.

The RFID antenna may be implemented in the form of an ink that is capable of responding to a modulated signal, for either sending or receiving an electromagnetic signal. The ink may be painted upon an object or a person. The ink, when activated by energy received from an associated RFID, will transmit a signal that is stored in an element associated with the RFID, therefore the RFID is tuned only to operate with the person having a mark indicated by the ink.

The system and method disclosed herein identifies the person having the RFID and based upon certain data or information in the RFID or in the computer, the person is permitted access to or use of objects, places and things. If the person is out of range of the RFID reader, the RFID reader and computer enters “sleep mode”, but periodically polls or checks for the RFID being in proximity of the reader.

The system may be used in conjunction with security codes, which are presented by the person. The RFID identification system and method may be used to confirm the security code by authenticating the presenter, for example, through a computer mouse.

The system and method of the invention will also be capable of reading a bar-code or some other code carried by on imprinted upon the person. Specifically, the bar code may be a tattoo or some other imprint made upon the person, which is used in conjunction with the RFID to identify the person.

With reference to the included drawings and description, an electronic device worn by a person, in a exemplary embodiment comprising a radio-frequency receiver-transmitter, an optionally a CODEC for generating a secret code or messages unique to that person, and a processing element having storage.

The device is made to operate within a location or venue, and if outside the location or venue, to transition to “sleep mode.”

The device communicates and interacts with other external systems. Optionally a CODEC, which enables secure communications, encodes and decodes messages and data exchanged with external systems. The CODEC may receive data or codes from the processing element and may send decoded data and or messages to the processing element for storage.

The processing element may receive and remit personal data related to the person, including the following:
1. Records of personal data and information, events and times related to that person.
2. Financial or monetary data.
3. Important dates and times with reminders
4. Security information including cryptographic keys and encodings.

### BRIEF DESCRIPTION OF DRAWINGS

FIG. 1A illustrates the hiding of an RFID in a ring worn by a person.

FIG. 1B shows other configurations of RFID enablement, wherein the RFID may be embedded in a badge worn by the person, or the RFID may be

FIG. 1C is a block diagram of the device as it may be worn by a person, wherein the device comprises an RFID, a processing element and optionally a CODEC for secure communications. The RFID communicates through a reader, which is controlled by a computer.

FIG. 1D shows the RFID embedded in some article carried by a person, the RFID communicating with an RFID reader made part of and secreted within a computer mouse.

FIG. 1E shows an RFID chip with a tattoo made by a radiating ink serving as an antenna.

FIG. 2A is a block diagram of the processing element that controls an RFID worn by a person.

FIG. 2B is a block diagram of the RFID worn to identify a person and to facilitate communications by the person.

FIG. 3 is a block diagram of the device interacting with an external system.

### DETAILED DESCRIPTION

### An Exemplary Embodiment

With reference to the included figures, the invention is practiced in the exemplary embodiment as an identifying device worn by a person. The identifying device comprises an RFID (radio frequency identifier), and may include a CODEC for secure communications and a processing element for controlling and processing data.

The device may be made part of or embedded in rings, watches, other jewelry, clothing, purses, wallets, credit cards, badges and so forth.

The device may store or contain information or data related to the person wearing the device. The information or data may be transmitted by the device and may be used to control access by the person or may be used to control activities by the person. The particular access or privilege is controlled by a computer or a special controller that is configured to grant access to places or objects. The computer may be networked to other computers and may collect or transmit data to the device.

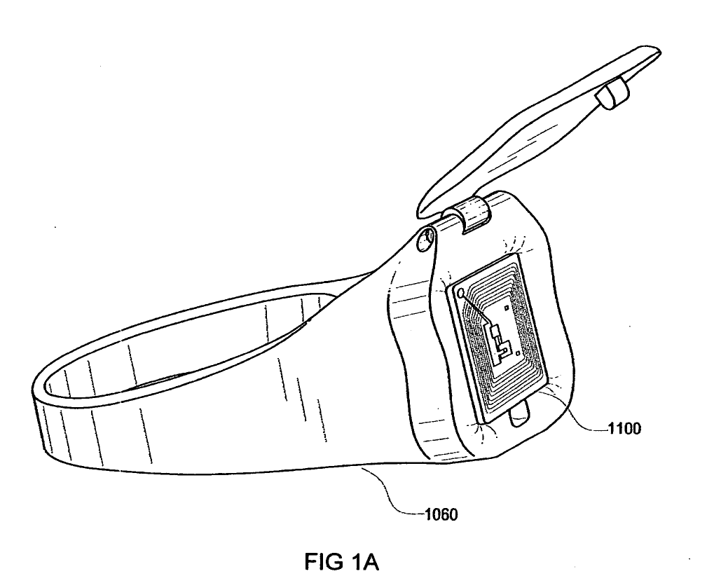

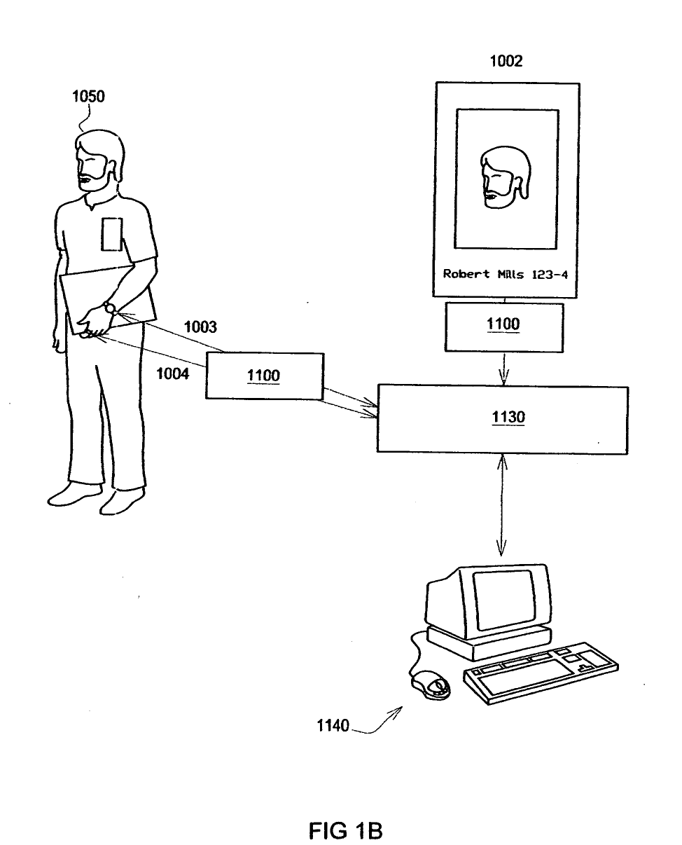

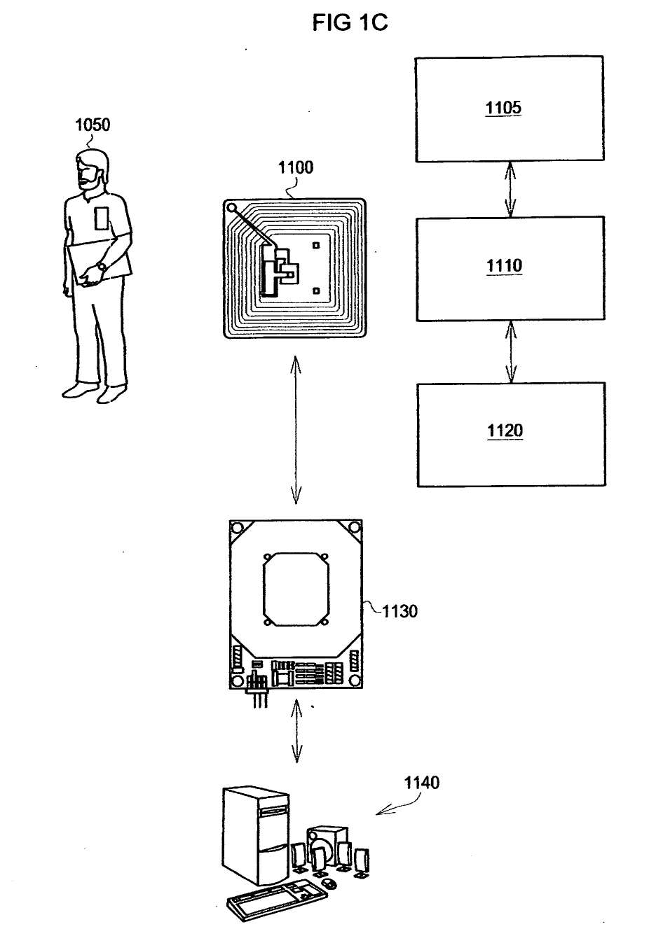

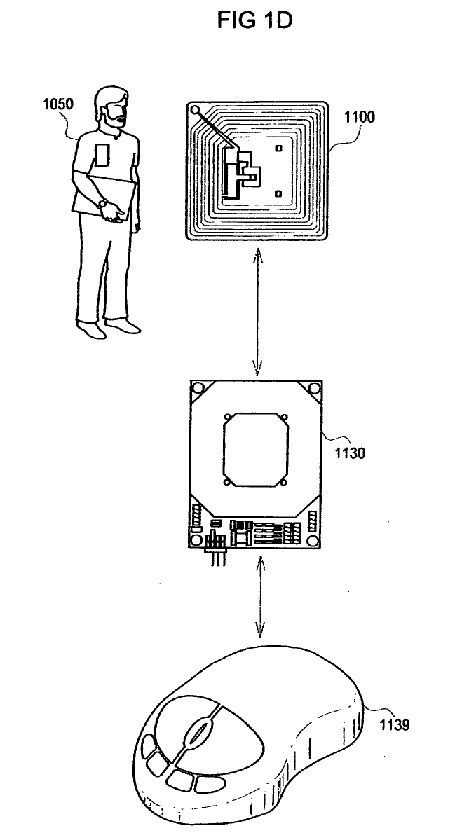

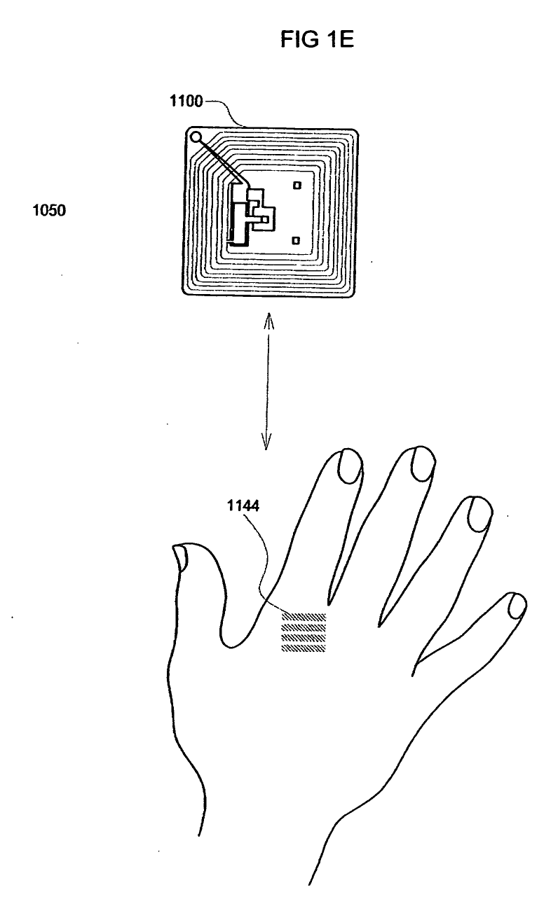

FIG. 1A shows, as an example, a ring 1060 having a compartment, wherein an identifying device 1100 is kept and which processes, transmits and receive data and information related to the person.

FIG. 1B illustrates a person 1050, with devices 1100 secreted in a badge 1002, a watch 1003, and a ring. An RFID in the device 1100 transmits, receives and processes data or information sent and received in signals (that may be encoded or encrypted), by means of a reader (having a receiver and a transmitter) 1130 that is connected to or communicates with a computer 1140. The device 1100 is made to communicate over a pre-specified distance from the reader 1130, and when the person/device 1050/1100 is outside that range the device 1100 enters “sleep” mode. The reader 1130 may poll devices in the general area monitored by the reader 1130. When a person 1050 wearing an identifying device 1100 enters the area, the device responds with data and information related to the person 1050. The data and information is used by the computer 1140 to grant permissions to the person 1050.

Further with reference to FIG. 1B, a tattoo or mark made upon the person 1050 may be read by the reader 1130, which may be equipped with a bar code reader. Therefore the bar code or tattoo reader will collect data that may be used in conjunction with or in lieu of data transmitted by the RFID in the device 1100.

Specifically and referring to FIG. 1C, a person 1050 wears or conceals an identifying device 1100 device having an RFID 1105, a processing element 1110, and optionally a CODEC 1120. The person 1050 comes into an area that is monitored by an RFID reader 1130. Energy is transmitted by the reader 1130, which activates the RFID is 1100. The RFID 1100 receives energy and, by action of the processing element 1110 or computes, retrieves and/or stores data. Data may be retrieved from the memory of the processing element 1110, which may be encoded by the CODEC 1130. Encoded data is sent by the RFID to the reader, which in turn may communicate with an external computer system 1140.

Refer now to FIG. 1D. A person 1050 carries or has somewhere on the person 1050 an object having an RFID 1100. The person 1050 comes into the vicinity or range of an RFID reader 1130. The RFID reader 1130 is contained or hidden within a computer mouse 1139.

The RFID reader 1130 is received inside the shell or physical cover of the mouse and configured to operate concurrently with the mouse by sharing a port into the computer or by having a separate USB (universal serial bus), by which signals are exchanged between the RFID reader 1130 and the computer to which the mouse 1139 is attached.

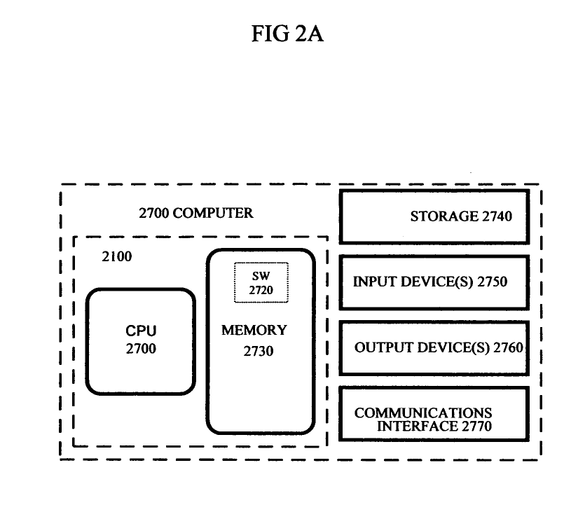

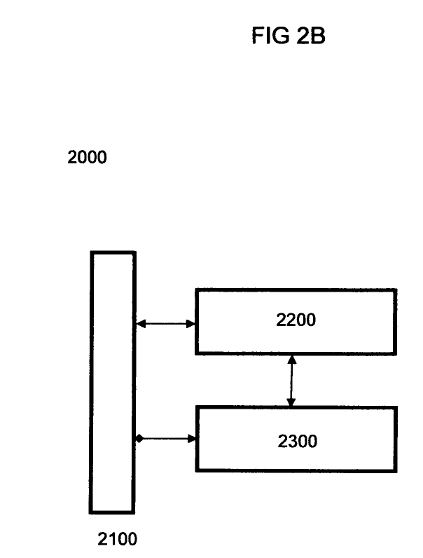

The RFID reader 1130 operates under control of software in the computer (see FIG. 1C) and refer to the description of the computer or processing element shown in FIG. 2A, which follows.

The computer mouse is controlled by a computer, such as shown in FIG. 1C. The RFID reader 1130 provides energy to the RFID 1100, which in return responds with an identifier associated with the person 1050. The RFID 1100 may interchange data with the computer (as shown in FIG. 1C) by way of the RFID reader 1130 embedded in the mouse 1139.

With respect to FIG. 1D, the person 1050 enters a security code or password into the computer and the RFID reader 1130 captures data from the RFID carried by the person 1050. Data captured by the RFID reader 1130 is used to authenticate the person 1050.

FIG. 1E shows an RFID chip 1100 that may be kept on a person of embedded within a person's skin, with a tattoo 1144 on the person, the tattoo made with ink capable of receiving or transmitting electromagnetic signals. The RFID chip 1100 may be direct contact with the tattoo 1144 or may interconnected by a current or signal carrying means such as a wire.

It will be appreciated that, for an ink having metallic content, the content may be varied in order to create an antenna having a specific resonance frequency or rang of frequency response. By varying the content of the ink, a tattoo may be made that will only respond to a pre-determined range of frequencies. In this way, the tattoo mark (ink) can be made to conform to a specific identity, and with an RFID carried on or in the person, the combination tattoo and RFID may be made to be unique to that person. Therefore access to a venue of access to or use of an object may be controlled.

### Processing Element

The processing element provides logical and physical control over components of the invention. More specifically, the processing element utilizes semiconductor technology to achieve extreme density of logical functions and data storage.

With reference to FIG. 2A, the processing element exercises control over the communications device and the CODEC. The processing element is configured to effect a computing environment 2000, which includes at least one processing unit 2700 and memory 2730. In FIG. 2A, this most basic configuration 2000 is included within a dashed line. The processing unit 2700 executes computer-executable instructions and may be a real or a virtual processor. In a multi-processing system, multiple processing units execute computer-executable instructions to increase processing power. The memory 2730 may be volatile memory (e.g., registers, cache, RAM), non-volatile memory (e.g., ROM, EEPROM, flash memory, etc.), or some combination of the two. The memory 2730 stores executable software—instructions and data 2250—written and operative to execute and implement the software applications required for an interactive environment supporting practice of the invention.

The computing environment may have additional features. For example, the computing environment 2000 includes storage 2740, one or more input devices 2750, one or more output devices 2760, and one or more communication connections or interfaces 2770. Due to the compact nature of the device, all storage is implemented as semi-conductor or solid-state memory.

An interconnection mechanism (not shown) such as a bus, controller, or network interconnects the components of the computing environment. Typically, operating system software (not shown) provides an operating environment for other software executing in the computing environment, and coordinates activities of the components of the computing environment.

The storage 2740 is used to store information and which can be accessed within the computing environment. For example, the storage may store certain personal and historical information related to the owner of the device. The storage 2740 also stores instructions for the software 2720, and is configured, for example, to store signal processing algorithms effect secure personal communications and control related to the owner of the device.

The communication interface 2770 enable the operating system and software applications, under control of the owner of the device, to exchange messages over a communication medium with other device owners. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The interface 2770 may be attached to a network, such as the Internet, whereby the computing environment 2000 interchanges command, control and feedback signals with other computers, devices, and other devices that are enabled to communicate via an RFID.

With reference to FIG. 2B, the processing element may be implemented as a FPGA (field-programmable gate array.) FIG. 2B illustrates the most FPGA architecture 2000 comprising logic/control 2200, optionally a CODEC 2300, and input/output 2100. The logic/control element 2200 has programming that controls the input/output 2100, which interfaces with an RFID. The FPGA is configured or made to implement all the processing functions illustrated and described with respect to FIG. 2A.

As further exemplification and description of FIG. 2B, a field-programmable gate array 2000 is a semiconductor device containing programmable logic components and programmable interconnects. The programmable logic components can be programmed to duplicate the functionality of basic logic gates such as AND, OR, XOR, NOT or more complex combinational functions such as decoders or simple mathematical functions. In most FPGAs, these programmable logic components (or logic blocks, in FPGA parlance) also include memory elements, which may be simple flip-flops or more complete blocks of memories.

An hierarchy of programmable interconnects allows the logic blocks of an FPGA to be interconnected as needed, somewhat like a one-chip programmable breadboard. These logic blocks and interconnects can be programmed after the manufacturing process by the customer/designer to implement any logical function—hence field-programmable.

The inherent parallelism of the logic resources on the FPGA allows for considerable compute throughput even at a sub-500 MHz clock rate.

The behavior of the FPGA is specified by a hardware description language (HDL) or a schematic design. Common HDLs are VHDL and Verilog. Using an electronic design automation tool, a technology-mapped netlist is generated. The netlist is adapted to the actual FPGA architecture using a process called place-and-route. The programmer of the FPGA validates the map, place and route results via timing analysis, simulation, and other verification methodologies. Once the design and validation process is complete, the binary file generated is used to (re)configure the FPGA.

Communications with the person with the device, preferably, will employ a radio-frequency identifier or RFID, which will now be described.

### RFID

The RFID is a microelectronic, low-cost, reliable transponder systems for electronic identification. Such transponder systems are often referred to as RFID tags, as it is generally assumed that their primary end application will be that of tagging a variety of goods, or in the case of the present invention, identifying and verifying the person using or wearing the device. In the interest of cost savings and miniaturization, RFID tags are generally manufactured as integrated circuits.

An RFID system may consist of several components: tags, tag readers, edge servers, middle-ware, and application software. The RFID enables data to be transmitted by the device. The output of the RFID is read by an RFID reader and processed according to the needs of a particular application. Data transmitted by the device RFID provides identification or location of the person and may under control of the processing element.

### Passive RFID Tags

A passive RFID has no internal power supply. The minute electrical current induced in the antenna by the incoming radio frequency signal provides just enough power for the CMOS integrated circuit (IC) in the RFID to power up and transmit a response. A passive RFID signals by backscattering the carrier signal from the reader. The RFID aerial (antenna) is designed to both collect power from the incoming signal and also to transmit the outbound backscatter signal. The response of a passive RFID is not just an ID number (GUID); the RFID chip has nonvolatile EEPROM for storing data. Since the RFID has no power supply, the device is very small and can be embedded under the skin. As of 2006, the smallest such devices measured 0.15 mm×0.15 mm, and are thinner than a sheet of paper (7.5 micrometers). The addition of the antenna creates an RFID that varies from the size of postage stamp to the size of a post card. Passive RFIDs have practical read distances ranging from about 2 mm (ISO 14443) up to a few meters (EPC and ISO 18000-6) depending on the chosen radio frequency and antenna design/size. Due to their simplicity in design they are also suitable for manufacture with a printing process for the antennas. Passive RFIDs have an unlimited life span.

### Semi-Passive RFID Tags

Semi-passive RFIDs are similar to passive tags except for the addition of a small battery. This battery allows the tag IC to be constantly powered, which removes the need for the aerial to be designed to collect power from the incoming signal. Aerials can therefore be optimized for the backscattering signal. Semi-passive RFID tags are faster in response, though less reliable and powerful than active tags.

### Active RFID Tags

Unlike passive RFID tags, active RFIDs have their own internal power source, which is used to power any ICs that generate the outgoing signal. Active RFIDs are typically much more reliable (e.g. fewer errors) than passive tags due to the ability for active RFIDs to conduct a communications session with a reader. Active RFIDs, with onboard power supply, also transmit at higher power levels than passive RFIDs, allowing them to be more effective in “RF challenged” environments, or at longer distances. Many active tags have practical ranges of hundreds of meters, and a battery life of up to 10 years. Some active RFIDs include sensors such as temperature logging. Other sensors that have been married with active RFID include humidity, shock/vibration, light, radiation, temperature and atmospherics. Active RFIDs typically have much longer range (approximately 300 feet) and larger memories than passive tags, as well as the ability to store additional information sent by the transceiver.

### RFID System

In the exemplary RFID system, and in reference to FIG. 1A, FIG. 1B and FIG. 1C, with accompanying description, the person possesses an identifying device having a small, inexpensive RFID. The RFID contains a transponder with a digital memory that has a unique electronic code that identifies the person. As previously described, the unique code may be rendered by a CODEC for security. The person's RFID interacts with an interrogator. The interrogator has an antenna packaged with a transceiver and decoder, and emits a signal activating the person's RFID. Activation of the person's RFID enables the RFID to transmit and to receive data. When an RFID tag passes through the electromagnetic zone, it detects the reader's activation signal. The reader decodes the data encoded in the person's RFID integrated circuit (silicon chip) and the data is passed to a network or to a computer. The application software on the computer processes the data, often employing Physical Markup Language (PML).

### RFID System Use

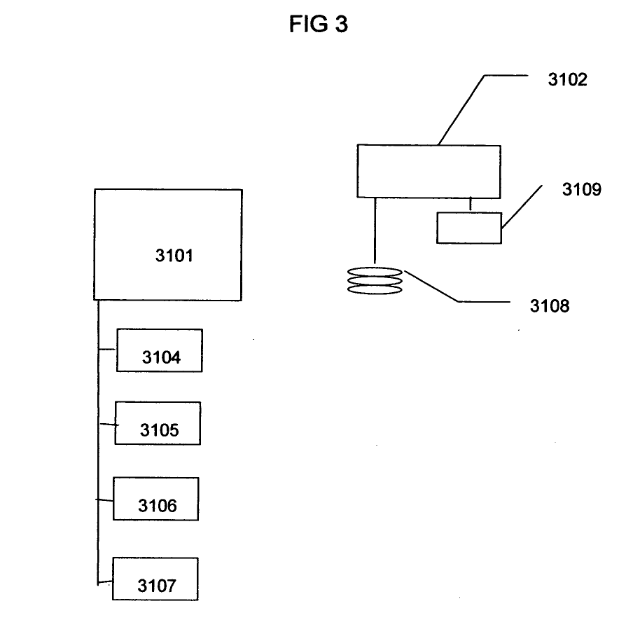

A description of the RFID system in this disclosure works follows. Referring now to FIG. 3, a proximity interrogation system 3000 includes an interrogator or reader 3101, a transponder (an RFID worn by the person) 3102, and a data processing terminal and/or computer system 3103. The reader 3101 generally includes a micro-controller 3104, a transmitter 3105, a receiver 3106, and a shared transmit/receive antenna 3107. The RFID 3102 worn by the person is typically passive (having no on-board power source, such as a battery) and includes at least an antenna 3108 (generally configured as a coil), and an application specific integrated circuit (ASIC) or FPGA 3109. As the tag 3102 receives its operational energy from the reader 3101, the two devices must be in close proximity. Within what is termed the surveillance zone, the reader generates sufficient power to excite the tag 3102. When radio frequency energy emanating from the reader's antenna 3107 impinges on the tag 3102 while it is in the surveillance zone, a current is induced in the coil of antenna 3108. This induced current is routed to the processing element (FPGA or ASIC) 3109, which then performs an initialization sequence. When the reader 3101 ceases transmitting its energy transmitting interrogation signal, the processing element 3109 begins to broadcast its identity and any other requested information over the RFID antenna 3108. The RFID transmission process utilizes low-energy transmission technology that selectively reflects the electromagnetic energy back to the reader at the same fundamental frequency as it was received, using the RFID antenna 3108 as an energy radiator. The transmit/receive frequency employed is generally application dependent. Commonly available proximity interrogation systems operate at frequencies in a range of 60 kHz to 5.8 GHz, and typically employ frequency modulation for data transmission. Information reflected by the RFID 3102 is decoded by the reader 3101.

The antenna or energy radiator 3108 may be a marking that is placed on the person, for example a “tattoo” that is capable or radiating energy.

Based upon information processed at the location of the reader 3101, data or codes are sent back to the RFID 3102 and is processed by the processing element 3109.

### DISCLOSURE SUMMARY

An exemplary embodiment of the present invention is disclosed to illustrate important aspects of an identifying device. The foregoing description of the structure, features and potential methods of use, of the device is intended to be illustrative and not for the purpose of limitation. The device is amenable to variation and further alternative embodiments, all within the scope of the invention as described above and set forth in the following claims.

1. A system for controlling access to a venue by a person, the system comprising:
an RFID device carried by the person, wherein the RFID has and transmits data relevant to the person; and
a processor, said processor receiving the transmitted data and controlling access to the venue according to the data received.

2. The system recited in claim 1, wherein the processor comprises an RFID reader embedded within a computer peripheral; wherein said computer peripheral is hand operated, and the RFID device is carried proximal to the user's hand, proximal being from the wrist to the fingers.

3. The system as recited in claim 2, wherein the computer peripheral is a computer mouse in communication with said processor.

4. The system as recited in claim 3, wherein the RFID device is embedded within a ring to be worn on a finger of the user.

5. The system as recited in claim 3, wherein the RFID device is embedded within a wrist watch or bracelet to be worn on a wrist by the user.

6. The system as recited in claim 3, wherein the RFID device is applied to the user's hand.

7. The system as recited in claim 6, wherein the RFID device comprises conductive antenna elements implanted within the user's hand.

8. The system as recited in claim 6, wherein the RFID device comprises a conductive antenna pattern applied as an ink to the skin of the user.

9. The system as recited in claim 8, wherein the RFID device comprises a conductive antenna pattern applied as a tattoo.

10. The system as recited in claim 8, wherein the conductive antenna pattern is utilized in the radio frequency and is also optically readable as a barcode.

11. The system as recited in claim 8, wherein the RFID device is readable by the RFID reader only within close proximity of the RFID reader to the RFID device.

12. A system for controlling access to a venue by a person, the system comprising:
1) a Radio Frequency Identification Device (RFID) carried by the person, wherein the RFID is configured in accordance with data relevant to the person, and the RFID is responsive to radio frequency probing signals;
2) a reader for probing said RFID with said radio frequency probing signals and receiving modified signals from said RFID in accordance with said data relevant to said person, and detecting said data relevant to said person; and
3) a processor receiving said data relevant to said person from said reader, wherein the processor controls access to the venue according to said data relevant to said person;
wherein said RFID comprises conductive antenna elements imprinted on the person.

13. The system as recited in claim 12, wherein the conductive antenna elements are applied as an ink to the skin of the user.

14. The system as recited in claim 12, wherein the conductive antenna elements are unique for identifying the user.

15. The system as recited in claim 12, wherein the RFID comprises a conductive antenna elements are applied as a tattoo.

16. The system as recited in claim 15, wherein the RFID comprises a chip in direct contact with the tattoo.

17. The system as recited in claim 15, wherein the RFID comprises a chip coupled to the tattoo by a wire.

18. The system as recited in claim 12, wherein the imprinted pattern contains metallic particles.

19. The system as recited in claim 12, wherein the imprinted pattern is made to respond to a predetermined range of frequencies.

20. The system as recited in claim 19, wherein the predetermined range of frequencies represents a specific identity.
